(19) United States
(12) Patent Application Publication
(10) Pub. No.: US 2022/0070978 A1
(43) Pub. Date: Mar. 3, 2022

(54) HEATER

(71) Applicant: KYOCERA Corporation, Kyoto-shi, Kyoto (JP)

(72) Inventor: Takeshi MUNEISHI, Kusatsu-shi, Shiga (JP)

(21) Appl. No.: 17/414,269

(22) PCT Filed: Dec. 26, 2019
(86) PCT No.: PCT/JP2019/051224

§ 371 Date: Jun. 15, 2021

(30) Foreign Application Priority Data
Dec. 26, 2018 (JP) 2018-242958

(51) Int. Cl. H05B 3/14; H05B 3/26; H05B 3/02

(52) U.S. Cl. CPC H05B 3/141; H05B 3/02; H05B 3/265

(57) ABSTRACT

A heater according to the present disclosure includes: a substrate (1) that includes a first surface, the substrate being made of a ceramic; and a first electric conductor (2a) that is arranged on the first surface, the first electric conductor including gaps (9).

### FIELD

The present disclosure relates to a heater.

### BACKGROUND

Conventionally, a heater has been broadly employed in various fields, in which a ceramic of an electrical insulator is used as a substrate and an electric conductive body as a heating element is formed on a surface of the substrate.

For example, in Patent Literature 1, there is disclosed a ceramic heater in which a heating generating pattern including a heating part and a lead-out part is formed on a surface of a ceramic electrical insulation layer.

### CITATION LIST

### Patent Literature

Patent Literature 1: Japanese Patent Application Laid-open No. 2004-178942

### SUMMARY

### Solution to Problem

A heater according to the present disclosure includes: a substrate that includes a first surface, the substrate being made of a ceramic; and a first electric conductor that is arranged on the first surface, the first electric conductor including gaps.

### Advantageous Effects of Invention

By employing a heater according to the present disclosure, a crack hardly occurs in a substrate even when it is repeatedly heated up and cooled down. Thus, it is possible to use it for a long time interval.

### BRIEF DESCRIPTION OF DRAWINGS

FIG. 1 is one example of a rear view illustrating a heater according to the present disclosure.

FIG. 2 is a cross-sectional view taken along a line A-A′ illustrated in FIG. 1.

FIG. 3 is one example of an enlarged view illustrating a part S illustrated in FIG. 2.

FIG. 4 is a cross-sectional view taken along a line B-B′ illustrated in FIG. 1.

FIG. 5 is another example of the cross-sectional view taken along the line B-B′ illustrated in FIG. 1.

FIG. 6 is a cross-sectional view taken along a line C-C′ illustrated in FIG. 1.

FIG. 7 is another example of the cross-sectional view taken along the line C-C′ illustrated in FIG. 1.

FIG. 8 is one example of an enlarged view illustrating the part S illustrated in FIG. 2.

FIG. 9 is an enlarged view illustrating a part T illustrated in FIG. 4.

### DESCRIPTION OF EMBODIMENTS

Hereinafter, a heater according to the present disclosure will be specifically explained with reference to accompanying drawings.

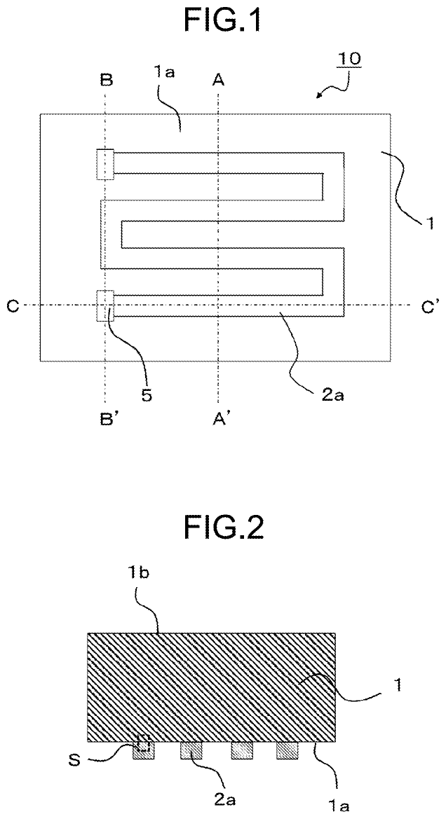

First, FIG. 1 is one example of a rear view illustrating a heater 10 according to the present disclosure, specifically, is a diagram viewing toward a first surface la of the heater 10. FIG. 2 is a cross-sectional view taken along a line A-A′ illustrated in FIG. 1. As illustrated in FIG. 1, the heater 10 according to the present disclosure includes a substrate 1 including the first surface la, and a first electric conductor 2a arranged on the first surface la, and when electricity is applied to the first electric conductor 2a, an object to be heated is able to be heated. As illustrated in FIG. 2a, a second surface lb is on an opposite side of the first surface la, and this surface is a surface that is close to an object to be heated, for example, may be a placement surface of the object to be heated. Furthermore, that the first electric conductor 2a is arranged on the first surface la means that the first electric conductor 2a is arranged on a surface of the first surface 1a.

The substrate 1 in the heater 10 according to the present disclosure is made of ceramic. As the ceramic, there are exemplified, for example, an aluminum-oxide-based ceramic, a silicon-carbide-based ceramic, a cordierite-based ceramic, a silicon-nitride-based ceramic, an aluminum-nitride-based ceramic, a mullite-based ceramic, and the like. Herein, when the substrate 1 is made of an aluminum-oxide-based ceramic, it has a high workability and further is inexpensive.

Herein, an aluminum-oxide-based ceramic contains equal to or more than 70% by mass of aluminum oxide of 100% by mass of all components constituting the ceramic. Material of the substrate 1 in the heater 10 according to the present disclosure may be identified by the following method. First, by using X-ray diffraction (XRD), the substrate 1 is measured to execute, by using the JCPDS card, identification from obtained values of 2θ (2θ is diffraction angle). Next, by using an X-ray fluorescence spectrometer (XRF), there is executed quantitative analysis of components. For example, presence of an aluminum oxide is recognized by the above-mentioned identification, when a content of aluminum (Al) measured by using XRF in terms of an aluminum oxide (Al₂O₃) is equal to or more than 70% by mass, the ceramic is an aluminum-oxide-based ceramic. Note that other ceramics may be identified by the same method.

With respect to thermal expansion coefficients of ceramics, commonly, a thermal expansion coefficient of aluminum-oxide-based ceramic is approximately 7.2 ppm, that of silicon-carbide-based ceramic is approximately 3.7 ppm, that of cordierite-based ceramic is approximately 1.5 ppm, that of silicon-nitride-based ceramic is approximately 2.8 ppm, that of aluminum-nitride-based ceramic is approximately 4.6 ppm, and that of mullite-based ceramic is approximately 5.0 ppm.

In FIGS. 1 and 2, there is exemplified the substrate 1 that is formed in rectangular-plate-shaped and that includes the first surface 1a and the second surface 1b opposite to the above-mentioned first surface la; however, not limited thereto, and it may have an arbitrary shape. Moreover, the first electric conductor 2a may be arranged in any position on the first surface la of the substrate 1.

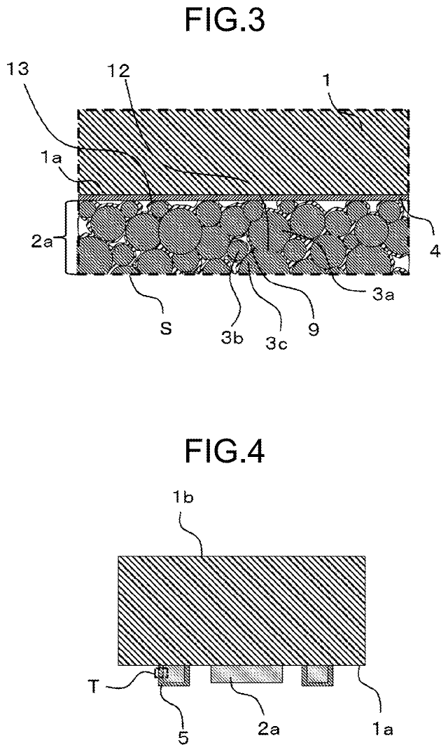

Next, FIG. 3 is an enlarged view illustrating a part S illustrated in FIG. 2. As illustrated in FIG. 3, the first electric conductor 2a in the heater 10 according to the present disclosure includes a plurality of gaps 9. The first electric conductor 2a may include first metal particles 3a and second metal particles 3b. The gaps 9 may be arranged between the first metal particles 3a and the second metal particles 3b.

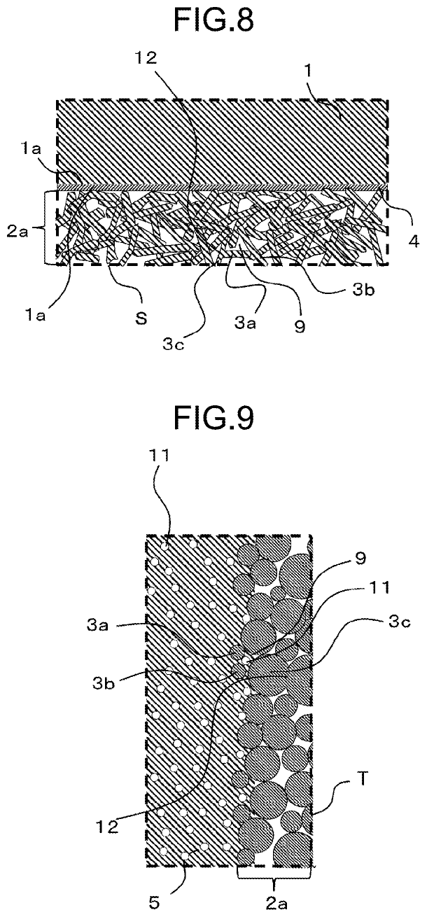

As illustrated in FIGS. 3 and 8, the first electric conductor 2a includes the gaps 9. Thus, a surface area of the first electric conductor 2a is larger than a surface area of an electric conductive layer without the gaps 9. Therefore, the heater 10 has a high heat dissipation.

As illustrated in FIGS. 3 and 8, the first electric conductor 2a may include the first metal particles 3a and the second metal particles 3b. The gaps 9 may be arranged between the first metal particles 3a and the second metal particles 3b. In a case of such a configuration, heat generated from the first metal particles 3a and the second metal particles 3b is absorbed into the gaps 9, thereby leading to a high heat dissipation of the heater 10.

It is sufficient that materials of the first metal particle 3a and the second metal particle 3b constituting the first electric conductor 2a are metal, and may be any of stainless, aluminum, and copper, for example. Commonly, a thermal expansion coefficient of stainless is approximately 10 ppm to 18 ppm, that of aluminum is approximately 23 ppm, and that of copper is approximately 16.7 ppm.

As illustrated in FIGS. 3 and 8, the first metal particle 3a and the second metal particle 3b may be formed in sphere-shaped, grain-shaped, whisker-shaped, or needle-shaped, for example. In a case where the first metal particle 3a and the second metal particle 3b are whisker-shaped or needle-shaped, the first metal particle 3a and the second metal particle 3b may be bent. The first metal particle 3a and the second metal particle 3b may include corner portions. In a case where the first metal particle 3a and the second metal particle 3b are sphere-shaped or grain-shaped, longitudinal directions of the first metal particle 3a and the second metal particle 3b may be equal to or more than 0.5 μm and equal to or less than 200 μm. In a case where the first metal particle 3a and the second metal particle 3b are whisker-shaped or needle-shaped, widths thereof may be equal to or more than 1 μm and equal to or less than 100 μm, and lengths thereof may be equal to or more than 100 μm and equal to or less than 5 mm.

In FIG. 3, the first metal particle 3a and the second metal particle 3b are grain-shaped. In FIG. 8, the first metal particle 3a and the second metal particle 3b are whisker-shaped.

In FIG. 1, there is exemplified the first electric conductor 2a that is meander-shaped; however, not limited thereto, may have any shape. An average thickness the first electric conductor 2a may be equal to or more than 1 μm and equal to or less than 5 mm, for example.

A porosity of the first electric conductor 2a may be equal to or more than 10% and equal to or less than 90%, for example. The porosity becomes an index that indicates an occupation ratio of the gaps 9 in the first electric conductor 2a. A porosity of the first electric conductor 2a may be calculated by measurement using the Archimedean principle, for example.

As illustrated in FIGS. 3 and 8, the first electric conductor 2a may include third metal particles 3c. The first electric conductor 2a may include a fuse-bonded section 12 between the first metal particles 3a and the third metal particles 3c. The first metal particle 3a and the third metal particle 3c are not simply in contact with each other, but are fused together, and thus heat is easily transmitted between the first metal particle 3a and the third metal particle 3c. Hence, the first electric conductor 2a as a whole has a high heat conductive efficiency. Therefore, the heater 10 has a high reliability.

As illustrated in FIG. 3, the heater 10 according to the present disclosure may include a bonding layer 4 between the first electric conductor 2a and the first surface 1a. When such a configuration is satisfied, the first electric conductor 2a is hardly peeled from the substrate 1, furthermore, the bonding layer 4 eases stress generated due to difference in a thermal expansion, so that a crack hardly occurs in the substrate 1. Thus, the heater 10 according to the present disclosure is able to be used for a longer time interval. An average thickness of a bonding layer 5 may be equal to or more than 1 μm and equal to or less than 0.5 mm, for example.

The bonding layer 4 of the heater 10 according to the present disclosure may be made of metal or glass. Herein, as the metal, for example, nickel, platinum, SUS, aluminum, copper, or the like may be exemplified, and as the glass, for example, borosilicate-based glass, silicate glass, or the like may be exemplified. When such a configuration is satisfied, the first electric conductor 2a and the substrate 1 are stiffly bonded to each other by the bonding layer 4, and thus the first electric conductor 2a is hardly peeled from the substrate 1.

Herein, when the bonding layer 4 is made of glass, a thermal expansion coefficient of glass is between those of metal and ceramic, and thus stress caused by difference in a thermal expansion between the first electric conductor 2a and the substrate 1 is effectively eased by the bonding layer 4, so that a crack hardly occurs in the substrate 1.

The bonding layer 4 of the heater 10 according to the present disclosure may be made of a porous ceramic. Herein, as the porous ceramic, for example, it is sufficient that the ceramic is the same as a ceramic constituting the substrate 1. When such a configuration is satisfied, the first metal particle 3a constituting the first electric conductor 2a penetrates into an inner part of the porous bonding layer 4, and thus the first electric conductor 2a and the bonding layer 4 are stiffly bonded to each other, furthermore, because both of the substrate 1 and the bonding layer 4 are ceramics, the substrate 1 and the bonding layer 4 are stiffly bonded to each other. Thus, the first electric conductor 2a is hardly peeled from the substrate 1.

FIG. 4 is a cross-sectional view taken along a line B-B′ illustrated in FIG. 1. As illustrated in FIGS. 1 and 4, a distal end part of the first electric conductor 2a in the heater 10 according to the present disclosure may be covered with a protection layer 5. Herein, the distal end part of the first electric conductor 2a means a part from a leading end of the first electric conductor 2a up to a length of 5 mm. Being covered with the protection layer 5 means that the protection layer 5 is arranged in contact with the distal end part of the first electric conductor 2a so that the distal end part of the first electric conductor 2a is not exposed to the outside.

When such a configuration is satisfied, a distal end part of the first electric conductor 2a is protected by the protection layer 5, to which stress is most easily applied to be broken when heating up and cooling down are repeated. Thus, the heater 10 according to the present disclosure is able to be used for a longer time interval.

Note that the protection layer 5 may be in contact with the substrate 1. When such a configuration is satisfied, the protection layer 5 reduces the possibility that a distal end part of the first electric conductor 2a is peeled from the substrate 1.

The protection layer 5 may be constituted of any material as long as the porosity is less than 5%. As illustrated in FIG. 9, the protection layer 5 may include a first component 11. For example, the first component 11 may be made of one selected from among ceramic, resin, metal, and glass. As a ceramic, for example, an aluminum-oxide-based ceramic, a silicon-carbide-based ceramic, a cordierite-based ceramic, a silicon-nitride-based ceramic, an aluminum-nitride-based ceramic, a mullite-based ceramic, or the like may be employed; as a resin, for example, a silicone resin, an imide-amide resin, or the like may be employed; as a metal, for example, nickel, platinum, copper, or the like may be employed; and as a glass, for example, a borosilicate-based glass, a silicate glass, or the like may be employed.

As illustrated in FIG. 9, a distal end part of the first electric conductor 2a in the heater 10 according to the present disclosure may include the first component 11 between the first metal particle 3a and the second metal particle 3b. When such a configuration is satisfied, the first electric conductor 2a and the protection layer 5 are stiffly bonded to each other, thereby leading to reducing possibility that the protection layer 5 is peeled from the first electric conductor 2a when heating up and cooling down are repeated.

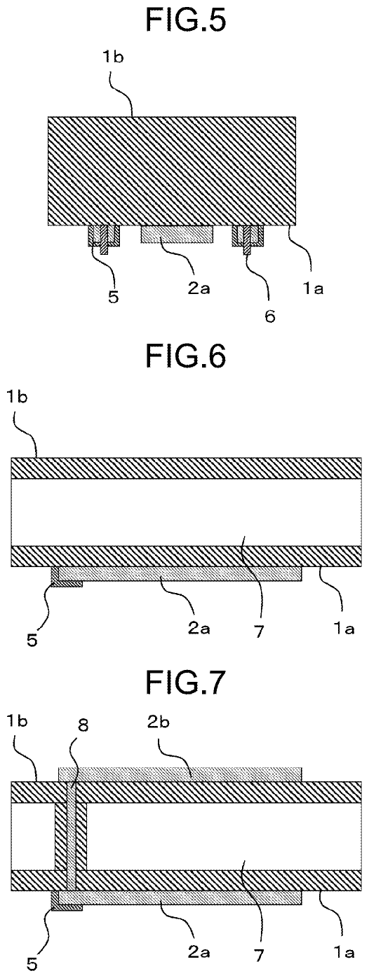

FIG. 5 is another example of the cross-sectional view taken along the line B-B′ illustrated in FIG. 1. As illustrated in FIG. 5, the heater 10 according to the present disclosure includes electric-power supplying terminals 6, at least a part of the electric-power supplying terminals 6 may be in an inner part of the first electric conductor 2a. Herein, the electric-power supplying terminals 6 are connected to a not-illustrated external power source so as to supply electric current to the first electric conductor 2a. When such a configuration is satisfied, possibility that the electric-power supplying terminals 6 fall out is small even when heating up and cooling down are repeated, so that it is possible to stably supply electric current to the first electric conductor 2a.

A metal particle 3 in the heater 10 according to the present disclosure may be covered with an oxide film 13. In a case where such a configuration is satisfied, when a cooling medium such as water flows inside of the first electric conductor 2a in order to cool down the heated first electric conductor 2a, it is possible to prevent a chemical reaction between the first electric conductor 2a and the cooling medium. Thereby leading to improving the reliability of the heater 10 according to the present disclosure.

As the oxide film 13, a metal oxide constituting the metal particle 3 may be employed.

FIG. 6 is a cross-sectional view taken along a line C-C′ illustrated in FIG. 1. As illustrated in FIG. 6, the substrate 1 in the heater 10 according to the present disclosure may include therein a flow path 7. In a case where such a configuration is satisfied, when causing the first electric conductor 2a to produce heat, fluid flowing through the flow path 7 is able to be heated up, so that it is possible to use the heater 10 according to the present disclosure as a chemical reaction device that causes the fluid to react by the heating up, for example.

FIG. 7 is another example of the cross-sectional view taken along the line C-C′ illustrated in FIG. 1. As illustrated in FIG. 7, the heater 10 according to the present disclosure further includes a second electric conductor 2b and a connection electric conductor 8, and the second electric conductor 2b may be arranged on the second surface lb, and the first electric conductor 2a and the second electric conductor 2b may be electrically connected to each other via the connection electric conductor 8.

When such a configuration is satisfied, the first electric conductor 2a, the connection electric conductor 8, and the second electric conductor 2b form a single electric conductive body, in a limited surface of the substrate 1, a length of the electric conductive body is able to be extended, so that it is possible to rapidly heat up the substrate 1 by using the electric conductive body. Furthermore, when the substrate 1 includes the flow path 7, fluid flowing through the flow path 7 is able to be rapidly heated up, so that it is possible to effectively facilitate reaction by heating up of the fluid, for example.

Similarly to the first electric conductor 2a, the second electric conductor 2b may include the gap 9.

Furthermore, the above-mentioned bonding layer 4 may be arranged between the second electric conductor 2b and the second surface 1b.

It is sufficient that a material constituting the connection electric conductor 8 is metal, and further the material may be the same metal as that of the metal particles 3 constituting the first electric conductor 2a and the second electric conductor 2b. Similarly to the first electric conductor 2a and the second electric conductor 2b, the connection electric conductor 8 may include the gaps 9.

The connection electric conductor 8 may have an arbitrary shape, when being formed in circle-columnar-shaped, a diameter thereof may be equal to or more than 0.3 mm and equal to or less than 2 mm. It is sufficient that the number of the connection electric conductors 8 is at least one, the number of the connection electric conductors 8 may be increased in accordance with amount of electric current to be used.

Next, one example of a manufacturing method of the heater according to the present disclosure will be explained

Sintering aid, binder, solvent, and the like are added to powder of raw material (aluminum oxide, silicon nitride, etc.) to be a main component, and they are mixed so as to fabricate a slurry. Next, by using the above-mentioned slurry, a green sheet is formed by the doctor blade method, and then punching using a die or laser processing is executed thereon so as to obtain a green sheet having a desired shape. Or the above-mentioned slurry is spray-dried to obtain granulated granules. Next, the above-mentioned granules are rolled to form a green sheet, and then punching using a die or laser processing is executed thereon so as to obtain a green sheet having a desired shape.

When executing punching using a die or laser processing, a hole to be a flow path and the like is formed in a green sheet and a plurality of green sheets is laminated to obtain a molded body, thereby forming the flow path. Or metal paste to be a connection electric conductor may be embedded in a molded body.

Next, the above-mentioned molded body is fired to obtain a substrate that is made of a ceramic and that includes a first surface.

Next, a first electric conductor is formed on the first surface of the substrate. First, a mask having a desired shape and made of a porous resin is formed on the first surface. Next, for example, there is prepared a mixed liquid obtained by mixing, with liquid such as water, a plurality of metal particles including a first metal particle and a second metal particle that are made of stainless, aluminum, or copper, and the mixed liquid is poured into a space formed by the above-mentioned mask.

Next, the mixed liquid is dried so as to evaporate the liquid. Next, the mask is removed by burning out or by using solvent, pressurization is executed thereon at a predetermined pressure, and then the substrate is heated up, or ultrasonic vibration is applied to the substrate. When a porous mask is removed, a first electric conductor including gaps is able to be obtained. When pressurization is executed at a predetermined pressure and then the substrate is heated up or ultrasonic vibration is applied to the substrate, the first metal particle and the second metal particle are able to be bonded to each other. Furthermore, when pressurization is executed at a predetermined pressure and then the substrate is heated up or ultrasonic vibration is applied to the substrate, a fuse-bonded section is able to be formed between the first metal particle and the third metal particle.

Note that a bonding layer may be formed on a first surface of the substrate and then a first electric conductor may be formed on the bonding layer instead of directly forming the first electric conductor on the first surface. Herein, the bonding layer is metal, glass, or a porous ceramic. When the bonding layer is metal, after forming the above-mentioned mask, the bonding layer may be formed by a sputtering method, an electroless plating method, or a metallizing method. On the other hand, when the bonding layer is glass or a porous ceramic, the bonding layer may be formed before forming the above-mentioned mask. In this case, the first surface may be coated with a paste whose main component is glass or a porous ceramic and then a thermal treatment may be executed thereon so as to form the bonding layer. Moreover, glass and a porous ceramic are electric insulation, and thus they may be formed so as to cover whole of a first surface of the substrate. A porous ceramic is easily bonded to the substrate as long as a component of the porous ceramic is the same as a component of a ceramic constituting the substrate.

After a first electric conductor is formed on the bonding layer, the substrate is heated up, when the bonding layer is metal or glass, the bonding layer is drenched with respect to the first electric conductor to be bonded thereto. When the bonding layer is a porous ceramic, a metal particle constituting the first electric conductor goes into the porous ceramic to be bonded thereto. When the bonding layer is metal, electricity is caused to flow into a bonding layer and a first electric conductor so as to bond metal of the bonding layer and a metal particle constituting the first electric conductor with each other, thereby leading to bonding the bonding layer and the first electric conductor with each other.

A first electric conductor may be separately prepared, the first electric conductor may be placed on a bonding layer previously formed on a first surface, or the first electric conductor may be coated with paste to be a bonding layer and then is placed on a first surface, and the substrate is heated up so as to obtain a substrate including the first electric conductor. In this case, the first electric conductor may be preliminary fabricated by the following method. First, for example, there is prepared a mixed liquid obtained by mixing, with liquid such as water, a plurality of metal particles made of stainless, aluminum, or copper to be poured into a mold having a shape of the first electric conductor. Next, this is dried to evaporate liquid. Next, pressurization is executed at a predetermined pressure and then heating or ultrasonic vibration is executed so as to bond the first metal particle and the second metal particle with each other. Next, when the work is taken out from the mold, there is obtained a first electric conductor in which a plurality of metal particles including the first metal particle and the second metal particle are fused to each other and including gaps.

Note that the first electric conductor may be fabricated by the following method. First, binder and a plurality of metal particles including a first metal particle and a second metal particle are mixed to each other so as to fabricate a molded body by a mechanical press method. Next, the above-mentioned molded body is dried to evaporate the binder. Next, heating up or ultrasonic vibration is executed thereon. Thus, a plurality of metal particles including the first metal particle and the second metal particle is able to be fused to each other. Thus, a fuse-bonded section is able to be formed between the first metal particle and the third metal particle. Hence, there is obtained a first electric conductor that includes gaps.

A second electric conductor may be formed on a second surface of the substrate by the same method as that of the above-mentioned first electric conductor.

In order to cover the metal particle with the oxide film 13, it is sufficient that an oxidation treatment by strong oxidizing agent, a heat treatment under an oxygen atmosphere, an anodic oxidation treatment, or the like is executed on metal particles so as to form, on surfaces of the metal particles, the oxide film 13 such as a passive film.

When a distal end part of the first electric conductor is covered with a protection layer, it is sufficient that a member made of any of ceramic, resin, metal, and glass may be bonded, as the protection layer, to the distal end part of the first electric conductor. Or a distal end part of the first electric conductor is coated with paste whose main component is any of ceramic, resin, metal, and glass, and further is dried and thermally treated so as to form a protection layer. Particularly, when using paste, it is possible to provide a first component constituting the protection layer between the first metal particle and the second metal particle in a distal end part of the first electric conductor.

Note that in order to provide at least a part of an electric-power supplying terminal in the first electric conductor, it is sufficient that a hole according to a shape of the electric-power supplying terminal is made in a distal end part of the first electric conductor, and the electric-power supplying terminal is inserted into the above-mentioned hole. In order to form the protection layer, it is sufficient that there is prepared a member including a hole into which an electric-power supplying terminal is to be inserted, and the above-mentioned member is bonded to a distal end part of the first electric conductor such that they are in contact with each other, or a distal end part of the first electric conductor and the electric-power supplying terminal are coated with the paste and then are dried and thermally treated.

The present disclosure is not limited to the above-mentioned embodiments, and various substitutions and changes in the form of the embodiments described herein may be made without departing from the spirit of the disclosure.

### REFERENCE SIGNS LIST

1 Substrate

1a First surface

1b Second surface

2a First electric conductor

2b Second electric conductor

3a First metal particle

3b Second metal particle

3c Third metal particle

4 Bonding layer

5 Protection layer

6 Electric-power supplying terminal

7 Flow path

8 Connection electric conductor

9 Gap

10 Heater

11 First component

12 Fuse-bonded section

13 Oxide film

1. A heater comprising:
a substrate that includes a first surface, the substrate being made of a ceramic; and
a first electric conductor that is arranged on the first surface, the first electric conductor including gaps.

2. The heater according to claim 1, wherein
the first electric conductor includes:
first metal particles; and
second metal particles, and
the gaps are between the first metal particles and the second metal particles.

3. The heater according to claim 2, wherein
the first electric conductor further includes third metal particles, and
the first electric conductor includes a fuse-bonded section between the first metal particle and the third metal particle.

4. The heater according to claim 1, further comprising:
a bonding layer between the first electric conductor and the first surface.

5. The heater according to claim 4, wherein
the bonding layer is made of one of metal and glass.

6. The heater according to claim 4, wherein
the bonding layer is made of a porous ceramic.

7. The heater according to claim 2, wherein
a distal end part of the first electric conductor is covered with a protection layer.

8. The heater according to claim 7, wherein
the protection layer includes a first component, and
the distal end part of the first electric conductor includes the first component between the first metal particle and the second metal particle.

9. The heater according to claim 7, further comprising:
an electric-power supplying terminal, wherein
a part of the electric-power supplying terminal is arranged in an inner part of the first electric conductor.

10. The heater according to claim 2, wherein the first metal particles and the second metal particles are covered with an oxide film.

11. The heater according to claim 1, wherein
the substrate includes therein a flow path.

12. The heater according to claim 1, further comprising:
a second electric conductor; and
a connection electric conductor, wherein
the substrate includes a second surface opposite to the first surface,
the second electric conductor is on the second surface, and
the first electric conductor and the second electric conductor are electrically connected via the connection electric conductor.

13. A manufacturing method of a heater, the method comprising:
preparing a substrate that includes a first surface, the substrate being made of a ceramic;
forming a space on the first surface by using a mask;
mixing first metal particles and second metal particles with liquid to prepare a mixed liquid;
pouring the mixed liquid into the space formed by the mask;
drying the mixed liquid to evaporate liquid;
removing the mask;
pressurizing the first metal particles and the second metal particles; and
heating the first metal particles and the second metal particles.

14. A manufacturing method of a heater, the method comprising:
preparing a substrate that includes a first surface, the substrate being made of a ceramic;
forming a space on the first surface by using a mask;
mixing first metal particles and second metal particles with liquid to prepare a mixed liquid;
pouring the mixed liquid into the space formed by the mask;
drying the mixed liquid to evaporate liquid;
removing the mask;
pressurizing the first metal particles and the second metal particles; and
applying ultrasonic vibration on the first metal particles and the second metal particles.

15. A manufacturing method of a heater, the method comprising:
mixing first metal particles, second metal particles, and a binder to prepare a mixed liquid;
forming the mixed liquid into a molded body by a mechanical press method;
drying the molded body to evaporate the binder;
heating the molded body to obtain a first electric conductor;
preparing a substrate that includes a first surface, the substrate being made of a ceramic; and
placing the first electric conductor on the first surface.

16. A manufacturing method of a heater, the method comprising:
mixing first metal particles, second metal particles, and a binder to prepare a mixed liquid;
forming the mixed liquid into a molded body by a mechanical press method;
drying the molded body to evaporate the binder;
applying ultrasonic vibration on the molded body to obtain a first electric conductor;
preparing a substrate that includes a first surface, the substrate being made of a ceramic; and
placing the first electric conductor on the first surface.
